(19) United States
(12) Patent Application Publication
(10) Pub. No.: US 2004/0105359 A1
(43) Pub. Date: Jun. 3, 2004

(54) Disc apparatus and tracking balance adjustment method

(75) Inventor: Kenji Takagi, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/680,190

(22) Filed: Oct. 8, 2003

(30) Foreign Application Priority Data
Nov. 29, 2002 (JP) 2002-347503
Jul. 17, 2003 (JP) 2003-198472

(51) Int. Cl. G11B 7/095

(52) U.S. Cl. 369/44.32; 369/53.28

(57) ABSTRACT

A disc apparatus according to one aspect of this invention includes a detection unit configured to detect a first tracking balance value by first adjustment in a tracking balance adjustment mode for controlling a light beam to trace along a track on a disc, and to detect a second tracking balance value by second adjustment different from the first adjustment, and an adjustment unit configured to adjust tracking balance on the basis of the first and second tracking balance values.

### CROSS-REFERENCE TO RELATED APPLICATIONS

This application is based upon and claims the benefit of priority from the prior Japanese Patent Applications No. 2002-347503, filed Nov. 29, 2002; and No. 2003-198472, filed Jul. 17, 2003, the entire contents of both of which are incorporated herein by reference.

### BACKGROUND OF THE INVENTION

1. Field of the Invention

The present invention relates to a disc apparatus which adjusts tracking balance so as to control a light beam to appropriately trace a track on an optical disc. The present invention also relates to a tracking balance adjustment method for adjusting tracking balance so as to control a light beam to appropriately trace a track on an optical disc.

2. Description of the Related Art

An increase in density of optical discs is achieved on the basis of an increase in line density and a decrease in track pitch. As the density of an optical disc becomes higher, the tracking balance adjustment result has a larger influence on recording/reproduction. That is, if the tracking balance is adjusted inappropriately, the recording/reproduction precision impairs.

As for tracking balance adjustment, various proposals have been made. For example, a technique for re-adjusting the tracking balance as needed by monitoring a tracking error signal is disclosed in Jpn. Pat. Appln. KOKAI Publication No. 2000-99964.

However, the tracking balance adjustment based on the technique disclosed in the above reference does not suffice. Especially, tracking balance adjustment with higher precision is demanded since discs have higher densities.

### BRIEF SUMMARY OF THE INVENTION

A disc apparatus according to one aspect of the present invention comprises a detection unit configured to detect a first tracking balance value by first adjustment, and to detect a second tracking balance value by second adjustment different from the first adjustment in a tracking balance adjustment mode for controlling a light beam to trace along a track on a disc, and an adjustment unit configured to adjust tracking balance on the basis of the first and second tracking balance values.

A tracking balance adjustment method according to one aspect of the present invention comprises: detecting a first tracking balance value by first adjustment, and detecting a second tracking balance value by second adjustment different from the first adjustment in a tracking balance adjustment mode for controlling a light beam to trace along a track on a disc; and adjusting tracking balance on the basis of the first and second tracking balance values.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing the arrangement of an optical disc apparatus according to an embodiment of the present invention;

FIG. 2 is a flow chart showing a tracking balance adjustment method according to an embodiment of the present invention;

FIG. 3 is a diagram showing an example of a tracking error signal generation process based on a push-pull method;

FIG. 4 is a chart showing an example of a tracking error signal generated by the push-pull method;

FIG. 5 is a view for explaining signal errors due to different sensitivity levels of respective detection regions of a photodetector; and

FIG. 6 is a view for explaining a case wherein a ball pattern cannot be normally detected.

### DETAILED DESCRIPTION OF THE INVENTION

An embodiment of the present invention will be described hereinafter with reference to the accompanying drawings.

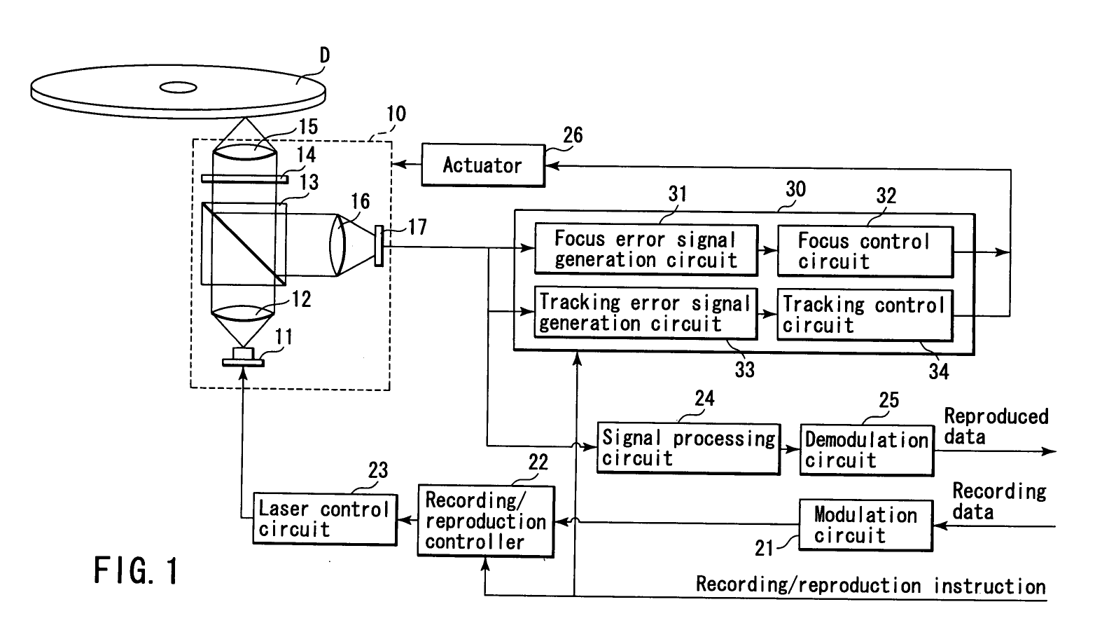

FIG. 1 is a schematic block diagram showing the arrangement of an optical disc apparatus according to an embodiment of the present invention. This optical disc apparatus records information on an optical disc D such as a CD-R, CD-RW, DVD-R, DVD-RW, DVD-RAM, or the like, and reproduces data recorded on such optical disc D.

As shown in FIG. 1, the optical disc apparatus comprises an optical pickup 10, modulation circuit 21, recording/reproduction controller 22, laser control circuit 23, signal processing circuit 24, demodulation circuit 25, actuator 26, and focus tracking controller 30.

The optical pickup 10 comprises a laser 11, collimator lens 12, polarization beam splitter (to be referred to as a PBS hereinafter) 13, quarter wave plate 14, objective lens 15, focusing lens 16, and photodetector 17.

The focus tracking controller 30 comprises a focus error signal generation circuit 31, focus control circuit 32, tracking error signal generation circuit 33, and tracking control circuit 34.

An information recording process on the optical disc D by the optical disc apparatus will be explained below. The modulation circuit 21 modulates recording information (data symbol) provided from a host to a predetermined channel bit sequence in accordance with a predetermined modulation scheme. The channel bit sequence corresponding to the recording information is input to the recording/reproduction controller 22. The recording/reproduction controller 22 also receives a recording/reproduction instruction (recording instruction in this case) from the host. The recording/reproduction controller 22 controls the actuator 26, and drives the optical pickup to appropriately focus a light beam at a target recording position. Furthermore, the recording/reproduction controller 22 supplies the channel bit sequence to the laser control circuit 23. The laser control circuit 23 converts the channel bit sequence into a laser drive waveform, and drives the laser 11. That is, the laser control circuit 23 pulse-drives the laser 11. With this control, the laser 11 emits a recording light beam corresponding to a desired bit sequence. The recording light beam emitted by the laser 11 is converted into collimated light by the collimator lens 12. The collimated light enters and is transmitted through the PBS 13. The beam transmitted through the PBS 13 passes through the quarter wave plate 14, and is focused by the focusing lens 15 on the information recording surface of the optical disc D. The focused beam is maintained in a state wherein it can form a best small spot on the recording surface, under the focus control of the focus control circuit 32 and actuator 26, and the tracking control of the tracking control circuit 34 and actuator 26. Note that details of the tracking control will be described later.

Next, a data reproduction process from the optical disc D by the optical disc apparatus will be described below. The recording/reproduction controller 22 receives a recording/reproduction instruction (reproduction instruction in this case) from the host. The recording/reproduction controller 22 outputs a reproduction control signal to the laser control circuit 23 in accordance with the reproduction instruction from the host. The laser control circuit 23 drives the laser 11 on the basis of the reproduction control signal. With this drive control, the laser 11 emits a reproduction light beam. The reproduction light beam emitted by the laser 11 is converted into collimated light by the collimator lens 12. The collimated light enters and is transmitted through the PBS 13. The light beam transmitted through the PBS 13 passes through the quarter wave plate 14, and is focused by the objective lens 15 on the information recording surface of the optical disc D. The focused reproduction light beam is maintained in a state wherein it can form a best small spot on the recording surface, under the focus control of the focus control circuit 32 and actuator 26, and the tracking control of the tracking control circuit 34 and actuator 26. Note that details of the tracking control will be described later. At this time, the reproduction light beam that strikes the optical disc D is reflected by a reflection film or reflective recording film in the information recording surface. The reflected light is transmitted through the objective lens 15 in the reverse direction, and is converted into collimated light again. The reflected light is transmitted through the quarter wave plate 14, and is reflected by the PBS 13 since it has a plane of polarization perpendicular to the incoming light. The beam reflected by the PBS 13 is converted into convergent light by the focusing lens 16, and enters the photodetector 17. The photodetector 17 comprises, e.g., a 4-split photodetector. The light beam that has entered the photodetector 17 is photoelectrically converted into an electrical signal, which is then amplified. The amplified signal is equalized and binarized by the signal processing circuit 24, and is then supplied to the demodulation circuit 25. The signal undergoes demodulation corresponding to a predetermined modulation method in the demodulation circuit 25, thus outputting reproduction data.

The focus error signal generation circuit 31 generates a focus error signal on the basis of some components of the electrical signal output from the photodetector 17. Likewise, the tracking error signal generation circuit 33 generates a tracking error signal on the basis of some components of the electrical signal output from the photodetector 17. The focus control circuit 32 controls the actuator 26 to control focusing of a beam spot on the basis of the focus error signal. The tracking control circuit 34 controls the actuator 26 to control tracking of a beam spot on the basis of the tracking error signal.

Details of the tracking control will be described below. The optical disc apparatus according to an embodiment of the present invention adjusts the tracking balance by two methods. One method adjusts the amplitude of a tracking error signal to be symmetrical about a reference signal. The other method adjusts the symmetry of a tracking error signal obtained by shifting the optical pickup 10 in the tracking direction.

The aforementioned two methods have both merits and demerits. The former method is suited to adjust any symmetry deviation caused by light amount balance, but cannot normally correct any errors due to lens shift. The latter method has a merit and demerit opposite to the former method. When the tracking balance is to be adjusted using one of these methods, a wrong tracking position may be detected depending on causes of balance errors.

Hence, the present invention adjusts the tracking balance using the two methods. Upon making a track search, it is desirable to appropriately adjust the symmetry of a tracking error signal. As for the reproduction & recording quality, it is required to normally trace an actual track position.

A tracking balance adjustment mode executed in the optical disc apparatus according to an embodiment of the present invention will be described below. The focus tracking controller 30 executes the tracking balance adjustment mode for making a light beam trace along a track on a disc at a predetermined timing. For example, the focus tracking controller 30 executes the tracking balance adjustment mode when the optical disc D is loaded into the optical disc apparatus.

In the tracking balance adjustment mode, the focus tracking controller 30 detects a first tracking balance value required to obtain the best tracking balance in a track search. For example, the first tracking balance value is detected to obtain the best symmetry of a tracking error signal.

Furthermore, in this tracking balance adjustment mode, the focus tracking controller 30 detects a second tracking balance value required to obtain the best tracking balance in a state wherein the light beam traces a track (in an actual recording/reproduction mode). The second tracking balance value is detected to obtain the best jitter of an RF signal obtained from the photodetector 17, to maximize the amplitude of the RF signal obtained from the photodetector 17, to maximize the amplitude of a track error signal obtained from the photodetector 17, or to obtain the best ATIP jitter obtained from the photodetector 17. The track on the optical disc is wobbled, and a jitter component obtained from this wobbled track is ATIP jitter.

Upon searching for a target track in response to the recording/reproduction instruction from the host, the focus tracking controller 30 adjusts the tracking balance on the basis of the first tracking balance value. In an actual recording/reproduction process, the focus tracking controller 30 adjusts the tracking balance on the basis of the second tracking balance value. More specifically, the tracking balance is adjusted based on the first tracking balance value upon searching for a target track, and is adjusted based on the second tracking balance value in an actual recording/reproduction process. In this manner, high-precision tracking control that exploits the merits of the two tracking balance adjustment methods can be implemented.

In addition to the method of controlling tracking by selectively using the first and second tracking balance values, the following tracking control is available. That is, a third tracking balance value is calculated on the basis of the first and second tracking balance values, and the tracking balance is adjusted on the basis of this third tracking balance value. Note that the third tracking balance value is, for example, a median of the first and second tracking balance values.

One of the first, second, and third tracking balance values may be used in tracking control upon making a track search, and another one may be used in tracking control in an actual recording/reproduction process. Alternatively, the third tracking balance value may be used in both cases, i.e., in a track search and actual recording/reproduction process.

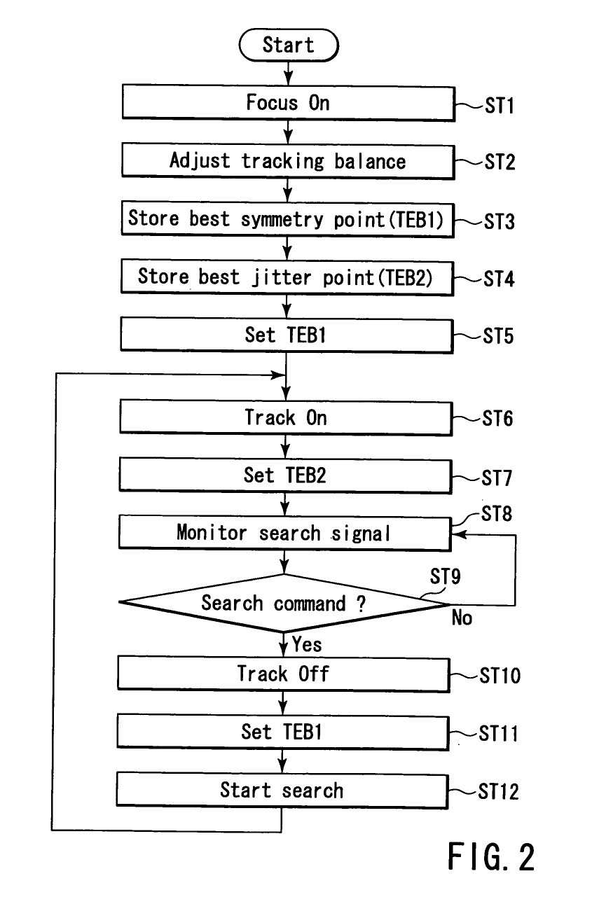

The tracking balance adjustment method will be described in more detail below with reference to the flow chart shown in FIG. 2. While a light beam coming from the optical pickup is in just focus on the disc (ST1), the control enters the tracking balance adjustment mode. In this case, two tracking balance values adjusted by different adjustment methods are detected. That is, a first tracking balance value (TEB1) is detected to obtain the best tracking balance during a track search. More specifically, the first tracking balance value (TEB1) is detected to obtain the tracking balance corresponding to the best symmetry of a tracking error signal. Also, a second tracking balance value (TEB2) is detected to obtain the best tracking balance during on-track. More specifically, the second tracking balance value (TEB2) is detected to obtain the tracking balance corresponding to the best jitter of a reproduced signal (ST2). The detected first and second tracking balance values are stored in the focus tracking controller 30 (ST3, ST4).

Upon searching for a target track in response to a recording/reproduction instruction from the host, the focus tracking controller 30 sets the first tracking balance value (TEB1) (ST5), and adjusts the tracking balance on the basis of the first tracking balance value (TEB1). As a result of this tracking balance adjustment, a light beam traces the track (track on) (ST6). In an actual recording/reproduction process, the focus tracking controller 30 sets the second tracking balance value (TEB2) (ST7), and adjusts the tracking balance on the basis of the second tracking balance value (TEB2).

During recording/reproduction, a search command from the host is monitored (ST8). If the host has issued a search command to another track (ST9, YES), tracing of the light beam with respect to the track is interrupted (track off) (ST10). The focus tracking controller 30 sets the first tracking balance value (TEB1) (ST11), and searches for the target track (ST12), thus controlling the light beam to trace the target track (track on) (ST6).

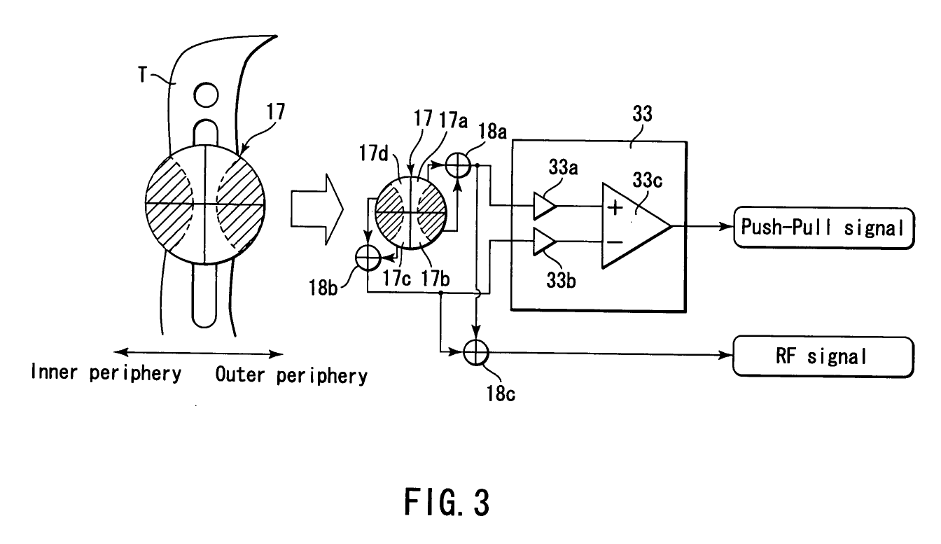

As an example of the tracking error signal generation method in the tracking error signal generation circuit 33, a push-pull method will be explained. FIG. 3 shows a tracking error signal generation process based on the push-pull method.

As described above, track T on the optical disc is wobbled. Light diffracted by this track T forms a ball pattern on the photodetector 17, as shown in FIG. 3. The photodetector 17 comprises, e.g., four-split photodetection regions, i.e., photodetection regions 17a, 17b, 17c, and 17d. The difference value between a sum signal of signals, which are detected by the two photodetection regions located on the inner periphery side to sandwich track T between them, and a sum signal of signals, which are detected by the two photodetection regions located on the outer periphery side to sandwich track T between them, is used as a tracking error signal called a push-pull signal.

More specifically, signals detected by the photodetection regions 17a and 17b are input to an adder 18a. The adder 18a adds the signals detected by the photodetection regions 17a and 17b, and outputs a sum signal. Likewise, signals detected by the photodetection regions 17c and 17d are input to an adder 18b. The adder 18b adds the signals detected by the photodetection regions 17c and 17d, and outputs a sum signal. Note that the adders 18a and 18b are not shown in FIG. 1.

The sum signal output from the adder 18a is electrically corrected (e.g., amplified) by a correction unit 33a included in the tracking error signal generation circuit 33, and is then input to a comparator 33c included in the tracking error signal generation circuit 33. On the other hand, the sum signal output from the adder 18b is electrically corrected (e.g., amplified) by a correction unit 33b included in the tracking error signal generation circuit 33, and is then input to the comparator 33c included in the tracking error signal generation circuit 33. The comparator 33c compares the two input signals, and outputs a comparison result, i.e., their difference value. This difference signal is a tracking error signal called a push-pull signal.

Note that the sum signals from the adders 18a and 18b are input to an adder 18c. The adder 18c generates the aforementioned RF signal by adding these two sum signals.

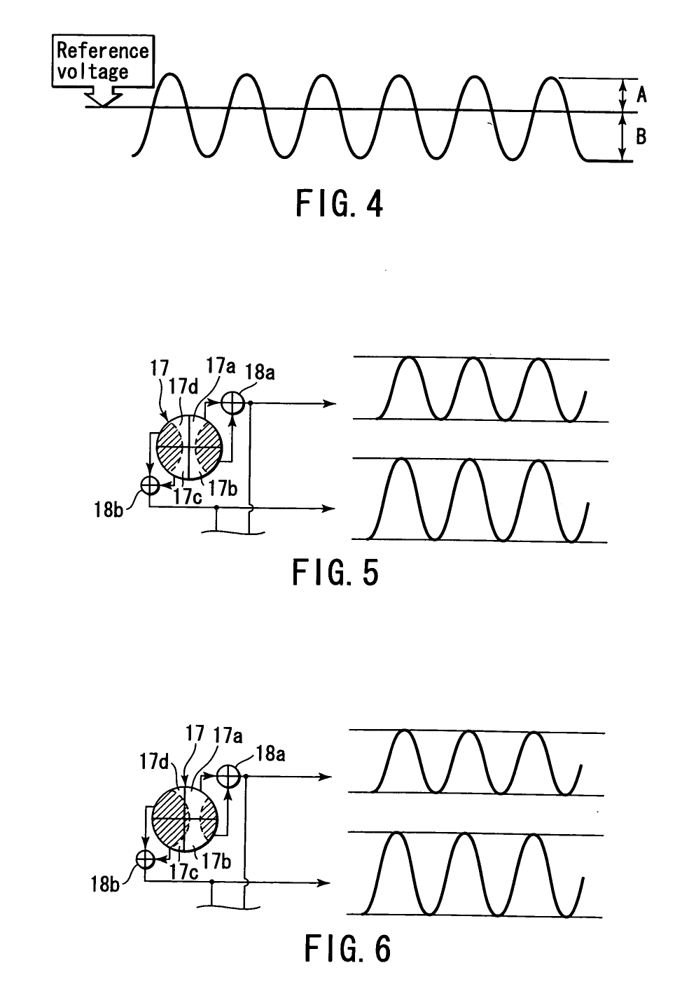

FIG. 4 shows an example of the tracking error signal generated by the push-pull method. If A and B are defined as follows, the ratio between A and B is the aforementioned tracking balance.

A: peak voltage of tracking error signal—reference voltage

B: reference voltage—bottom voltage of tracking error signal

Assume that all electrical offsets that signals output from the photodetector 17 receive from respective circuit are canceled.

In the conventional method, the signals output from the photodetector undergo electrical correction to achieve A=B while placing an importance on the tracking balance symmetry. This is to improve the tracking servo stability. However, such correction is an adjustment method limited to servo performance, and cannot always be means for improving the recording/reproduction quality.

Causes of tracking balance errors will be examined below. Tracking balance errors are produced by the following causes.

Cause 1: sensitivity balance error of photodetector

Cause 2: optical offset due to lens shift, etc

Cause 3: quality of focus spot

In case of cause 1, if a uniform ball pattern is formed on the photodetector 17, the sum signal of the signals detected by the photodetection regions 17a and 17b should be equal to that of the signals detected by the photodetection regions 17c and 17d. However, even when a uniform ball pattern is formed on the photodetector 17, the sum signal of the signals detected by the photodetection regions 17a and 17b does not often match that of the signals detected by the photodetection regions 17c and 17d due to sensitivity differences (sensitivity errors) of the photodetection regions 17a, 17b, 17c, and 17d. In such example, even when a tracking balance error has occurred, since the objective lens normally traces a track in practice, the conventional electrical correction is effective.

In case of cause 2, a focus spot itself formed on the disc cannot normally trace a track due to lens shift or the like. In such case, the photodetector 17 detects a ball pattern shown in FIG. 6, and the track cannot be normally traced even by electrically correcting the tracking error signal. After the objective lens 15 is moved to a correct position by applying a bias to the actuator, the tracking error signal must be monitored.

Causes 1 and 2 above correspond to a case wherein the focus spot is an ideal one free from any aberrations. However, in practice, an unideal focus spot is present. Cause 3 assumes such case. If an optical system suffers aberrations, since the spot shape is unstable, various ball patterns are formed on the photodetector. It is hard to search for an ideal tracking servo point on the basis of tracking error signals generated based on such ball patterns. If all focus spots are ideal ones, it is very difficult to separate causes of tracking balance errors since there is no means for detecting the absolute position of the objective lens 15. For this reason, a new index that can replace the conventional method which adjusts based on only a servo error signal is required.

Hence, the aforementioned problems can be solved by adopting the tracking balance adjustment method of the present invention.

As described above, the optical disc apparatus according to the present invention controls the tracking balance on the basis of a tracking balance value which is optimal to a track search upon searching for a target track, and controls the tracking balance on the basis of a tracking balance value which is optimal to recording/reproduction in an actual recording/reproduction process. In this manner, high-precision tracking control can be implemented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disc apparatus comprising:
a detection unit configured to detect a first tracking balance value by first adjustment, and to detect a second tracking balance value by second adjustment different from the first adjustment in a tracking balance adjustment mode for controlling a light beam to trace along a track on a disc; and
an adjustment unit configured to adjust tracking balance on the basis of the first and second tracking balance values.

2. An apparatus according to claim 1, wherein the detection unit detects the first tracking balance value on the basis of symmetry of a signal obtained from light reflected by the disc, and detects the second tracking balance value on the basis of jitter of the signal obtained from the light reflected by the disc.

3. An apparatus according to claim 1, wherein the adjustment unit adjusts the tracking balance on the basis of the first tracking balance value in response to a track search instruction, and adjusts the tracking balance on the basis of the second tracking balance value when the track search is complete and the light beam traces the track.

4. An apparatus according to claim 1, wherein the adjustment unit calculates a third tracking balance value on the basis of the first and second tracking balance values, and adjusts the tracking balance on the basis of the third tracking balance value.

5. A tracking balance adjustment method comprising:
detecting a first tracking balance value by first adjustment, and detecting a second tracking balance value by second adjustment different from the first adjustment in a tracking balance adjustment mode for controlling a light beam to trace along a track on a disc; and
adjusting tracking balance on the basis of the first and second tracking balance values.

6. A method according to claim 5, wherein the first tracking balance value is detected on the basis of symmetry of a signal obtained from light reflected by the disc, and the second tracking balance value is detected on the basis of jitter of the signal obtained from the light reflected by the disc.

7. A method according to claim 5, wherein the tracking balance is adjusted on the basis of the first tracking balance value in response to a track search instruction, and is adjusted on the basis of the second tracking balance value when the track search is complete and the light beam traces the track.

8. A method according to claim 5, wherein a third tracking balance value is calculated on the basis of the first and second tracking balance values, and the tracking balance is adjusted on the basis of the third tracking balance value.
